(19) United States
(12) Patent Application Publication
(10) Pub. No.: US 2012/0048201 A1
(43) Pub. Date: Mar. 1, 2012

(54) DIRECTIONAL FEEDER FOR FISH AND GAME

(76) Inventor: Benning Qian, Ningbo (CN)

(21) Appl. No.: 12/871,317

(22) Filed: Aug. 30, 2010

(51) Int. Cl. A01K 5/02; A01K 29/00

(52) U.S. Cl. 119/57.92; 119/61.2

(57) ABSTRACT

A directional feeder for fish and game comprising a housing having a gate below an opening in a feed hopper and above a substantially horizontally aligned auger. The gate has a feed opening through which the feed pellets are passed from the feed hopper to the auger. The auger directs the feed pellets to a chute, where the feed pellets are gravity feed to a paddle wheel for dispersion. The paddle wheel has a plurality of radially projecting blades in close proximity to an inside wall of the housing to scoop the entering feed pellets and accelerate the pellets along the inside wall of the housing until an exit port is reached. When the accelerated feed pellets reach the exit port of the direction feeder, the feed pellets' inertia carries them out the exit port for dispersion.

### BACKGROUND OF THE INVENTION

1. Field of the Invention

This invention relates generally to a directional feeder for fish and game, and more particularly to a directional feeder for fish and game having a substantially horizontal auger that directs feed pellets to a paddle wheel for dispersion.

2. Description of the Related Art

Directional feeders widely disperse animal feed over a relatively broad area and make it easy to distribute game or fish feed automatically, such as shelled corn, soybeans and pelletized feed. Directional feeders provide critical food during key stages of the game or fish's growth and encourage a healthier population.

It is therefore desirable to provide a directional feeder for fish and game having a substantially horizontal auger that directs feed pellets to a paddle wheel for dispersion.

It is further desirable to provide a directional feeder for fish and game comprising a dual motor directional feeder having a slidable gate below an opening in a feed hopper and above a substantially horizontal auger. The gate has a feed opening through which feed pellets are passed from the feed hopper into the auger, which directs the feed pellets to a chute, where the feed pellets are gravity feed to a paddle wheel for dispersion.

### SUMMARY OF THE INVENTION

In general, in a first aspect, the invention relates to a directional feeder for fish and game comprising a housing having a front, a back, a top and a bottom. The top of the housing has a feed opening and may have a pair of brackets, such as a pair of substantially inverted L-shaped brackets, secured thereto intermediate of the front and the rear of the housing. A mounting bracket may be removably secured to the pair of brackets on the top of the housing, and the mounting bracket has a feed opening therethrough. The mounting bracket may include a pair of channels with a mating configuration to the pair of brackets on the top of the housing. The directional feeder also includes a gate slidably engaged to the housing, with the gate having a feed opening therethrough. Further, a substantially horizontal auger is rotatably disposed within an upper substantially cylindrical channel of the housing, while a paddle wheel is rotatably disposed within a lower substantially cylindrical channel of the housing. The paddle wheel includes a plurality of radially projecting blades in close proximity to an inner wall of the lower substantially cylindrical channel of the housing, and the paddle wheel may also include a substantially vertical base plate. In addition, a curved feed chute is intermediate of the upper substantially cylindrical channel of the housing and the lower substantially cylindrical channel of the housing. The lower substantially cylindrical channel of the housing includes an exit port. Moreover, the feed opening of the top of the housing, the feed opening of the mounting bracket and the feed opening of the gate may be axially spaced and coaxially aligned. A center axis of the feed opening of the top of the housing may be substantially perpendicular to a center axis of the paddle wheel, while the center axis of the paddle wheel may be substantially perpendicular to a center axis of the auger.

Each of the brackets on the top of the housing may include a tapered edge such that each of the substantially inverted L-shaped brackets is wider towards the rear of the housing. Further, the mounting bracket may include a pair of latches at a rear portion for securing the mounting bracket to the pair of brackets. In addition, a directional exit chute may be secured to a front cover about the exit port on the front of the housing. A hinged door may be releasably secured to the rear of the housing by way of a pair of hinges and a door latch.

The directional feeder may further include a first motor housed within a first motor housing secured to the housing. The first motor has an axle, rotation of which is transferred to the auger via a series of gear sprockets. The directional feeder may also include a second motor having an axle, and the second motor is housed within a second motor housing secured to the housing. The axle of the second motor is secured to a center axis of the paddle wheel. In addition, at least one power supply may be included for powering the first motor and the second motor.

In general, in a second aspect, the invention relates to a directional feeder for fish and game comprising a housing having a front, a back, a top and a bottom. The front of the housing may include a front cover removably secured thereto, and the top of the housing has a feed opening. The housing also has an upper substantially cylindrical channel and a lower substantially cylindrical channel with a curved feed chute intermediate thereof. The lower substantially cylindrical channel includes an exit port. In addition, the top of the housing may include a pair of brackets intermediate of the front and the rear of the housing. A mounting bracket is removably secured to the pair of brackets on the top of the housing and includes a feed opening therethrough. A substantially planar gate is slidably engaged to the mounting bracket and also includes a feed opening therethrough. A substantially horizontal auger is rotatably disposed within the upper substantially cylindrical channel of the housing, and a paddle wheel is rotatably disposed within the lower substantially cylindrical channel of the housing. The paddle wheel has a substantially vertical base plate and a plurality of radially projecting blades in close proximity to an inner wall of the lower substantially cylindrical channel of the housing.

In addition, the directional feeder may include a first motor housed within a first motor housing secured to the housing. The first motor has an axle, and rotation of the axle of the first motor is transferred to the auger via a series of gear sprockets. A second motor is housed within a second motor housing secured to the housing of the directional feeder. The second motor has an axle, which is secured to a center axis of the paddle wheel. Further, the directional feeder includes at least one power supply for powering the first motor and the second motor.

Additionally, at least the feed opening of the top of the housing and the feed opening of the gate are axially spaced and coaxially aligned, the axis of the feed opening of the top of the housing is substantially perpendicular to a center axis of the paddle wheel, and the center axis of the paddle wheel is substantially perpendicular to a center axis of the auger.

Each of the brackets of the pair of brackets on the top of the housing may have a substantially inverted L-shape, and the mounting bracket may include a pair of channels having a mating configuration with the substantially inverted L-shaped brackets. Further, each of the substantially inverted L-shaped brackets can include a tapered edge such that each of the substantially inverted L-shaped brackets is wider toward the rear of the housing. The mounting bracket may also have a pair of latches at a rear portion for securing the mounting bracket to the pair of brackets.

The directional feeder may also include a directional exit chute secured to the front of the housing and a hinged door releasably secured to the rear of the housing by way of a pair of hinges and a door latch.

### BRIEF DESCRIPTION OF THE DRAWINGS

FIG. 1 is a perspective view of an example of a directional feeder having a mounting bracket, a front cover and a directional exit chute in accordance with an illustrative embodiment of the directional feeder for fish and game disclosed herein;

FIG. 2 is a rear plan view of the directional feeder shown in FIG. 1;

FIG. 3 is a perspective view of an example of a housing in accordance with an illustrative embodiment of the directional feeder for fish and game disclosed herein;

FIG. 4 is a top plan view of the directional feeder shown in FIG. 1;

FIG. 5 is a perspective partial cutaway view of the directional feeder shown in FIG. 1;

FIG. 6 is a perspective view of the directional feeder shown in FIG. 1 with the front cover removed;

FIG. 7 is a rear plan view of the directional feeder shown in FIG. 3; and

FIG. 8 is a perspective view of an example of a first motor in accordance with an illustrative embodiment of the directional feeder for fish and game disclosed herein.

Other advantages and features will be apparent from the following description and from the claims.

### DETAILED DESCRIPTION OF THE INVENTION

The devices discussed herein are merely illustrative of specific manners in which to make and use this invention and are not to be interpreted as limiting in scope.

While the devices have been described with a certain degree of particularity, it is to be noted that many modifications may be made in the construction and the arrangement of the structural and function details disclosed herein without departing from the spirit and scope of this disclosure. It is understood that the devices are not limited to the embodiments set forth herein for purposes of exemplification.

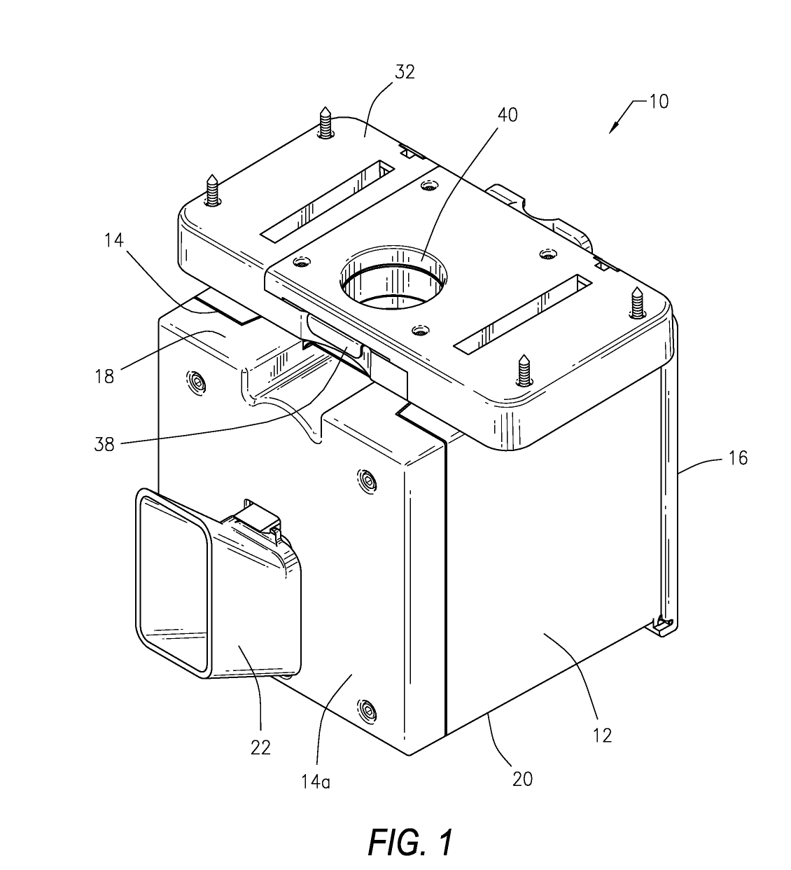

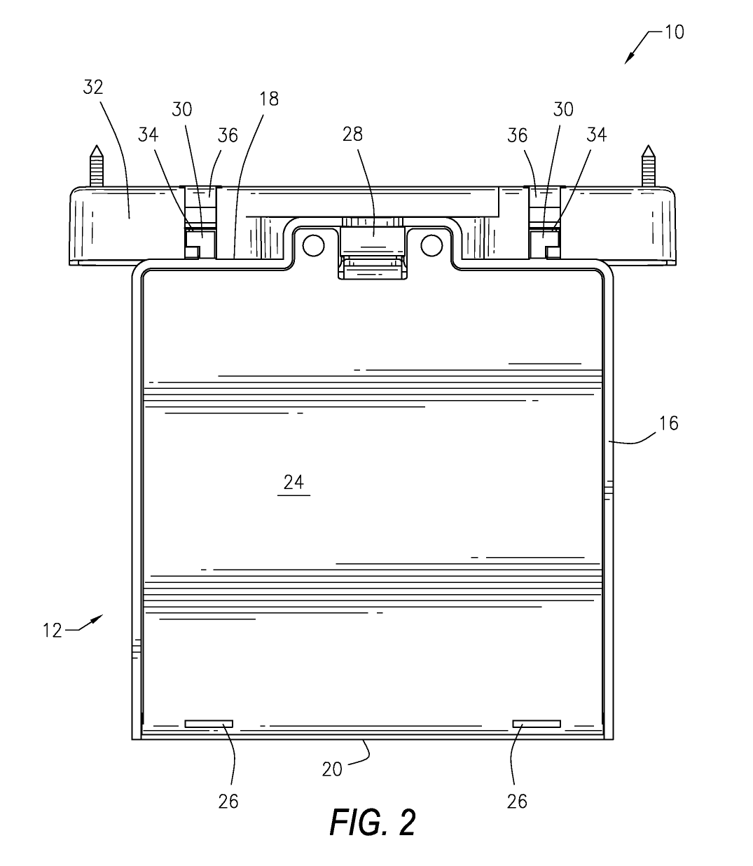

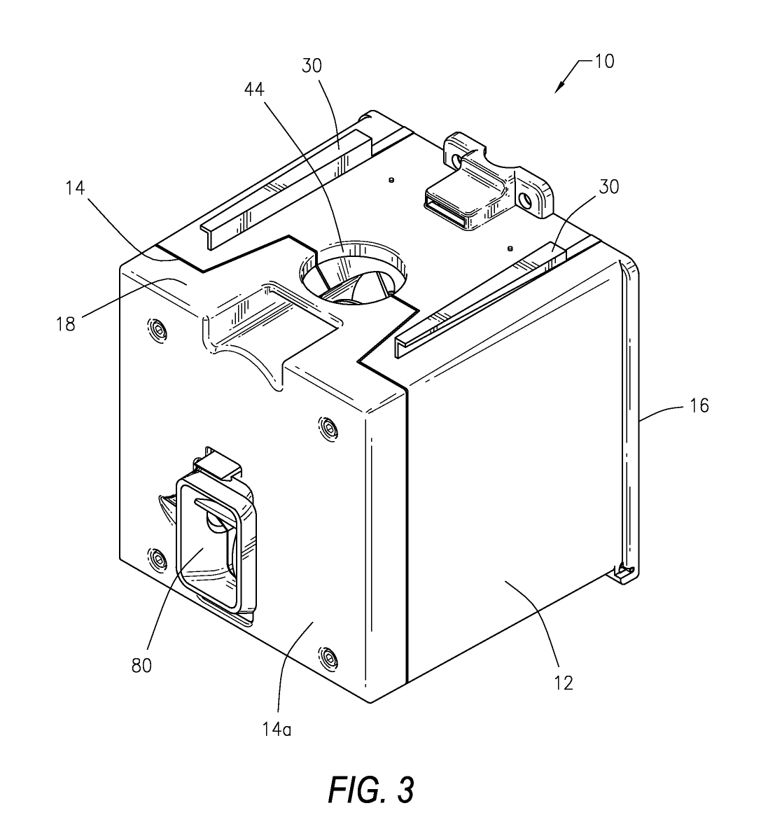

Referring to the figures of the drawings, wherein like numerals of reference designate like elements throughout the several views, and initially to FIGS. 1 through 3, a directional feeder for fish and game 10 comprising a housing 12 having a front 14, a back 16, a top 18 and a bottom 20. The front 14 of the housing 12 may include a front cover 14a removably secured thereto. A directional exit chute 22 may be secured to the front cover 14a of the housing 12, while a hinged door 24 may be releasably secured to the rear 16 of the housing 12 by way of a pair of hinges 26 and a door latch 28. A pair of substantially inverted L-shaped brackets 30 is secured to the top 18 of the housing 12 intermediate of the front 14 and the rear 16 of the housing 12. A mounting bracket 32 is removably secured to the pair of substantially inverted L-shaped brackets 30 via a pair of channels 34 having a mating configuration with the substantially inverted L-shaped brackets 30. The mounting bracket 32 allows the directional feeder 10 to be secured to a feed hopper (not shown). As can be seen in FIG. 3, each of the substantially inverted L-shaped brackets 30 has a tapered edge, such that each of the substantially inverted L-shaped brackets 30 is wider towards the rear 16 of the housing 12, allowing the mounting bracket 32 to be slideably engaged therewith. In addition, the mounting bracket 32 may include a pair of latches 36 at a rear portion for locking the mounting bracket 32 to the pair of substantially inverted L-shaped brackets 30 of the housing 12.

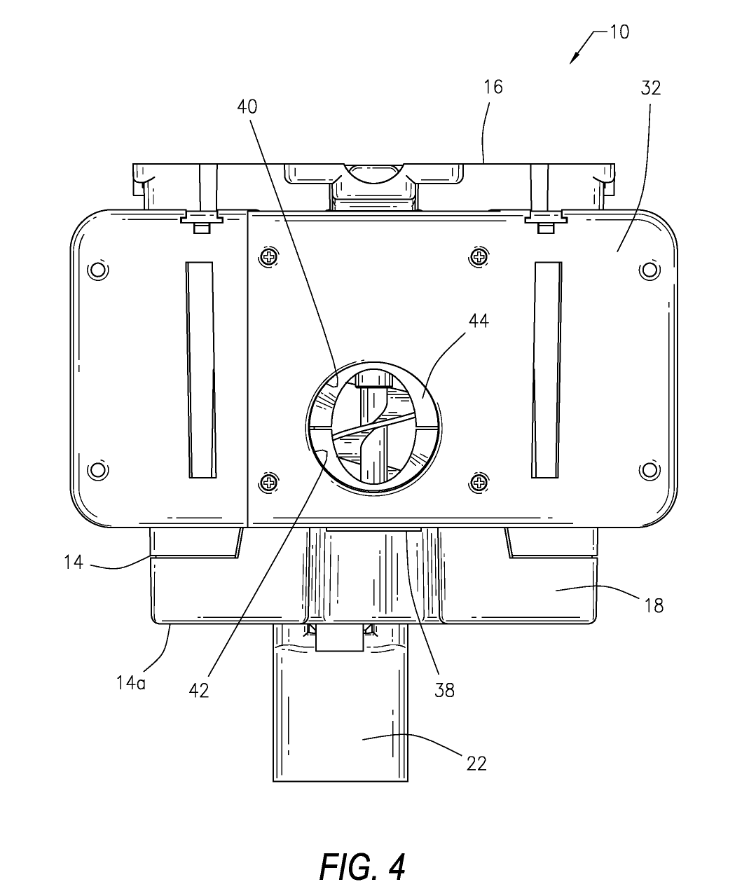

The mounting bracket 32 also includes a substantially planar gate 38 slidably engaged therewith. The mounting bracket 32, the gate 38 and the top 18 of the housing 12 each include a feed opening 40, 42 and 44, respectively. As can be seen in FIG. 4, during operation, when the gate 38 is in an open position, the feed openings 40, 42, and 44 of the mounting bracket 32, the gate 38 and the top 18 of the housing 12, respectively, are all axially aligned, thereby allowing feed pellets (not shown) to flow from the feed hopper, through the feed opening 40 of the mounting bracket 32, through the feed opening 42 of the gate 38, through the feed opening 44 in the top 18 of the housing 12 and into the housing 12 of the directional feeder 10 for dispersion.

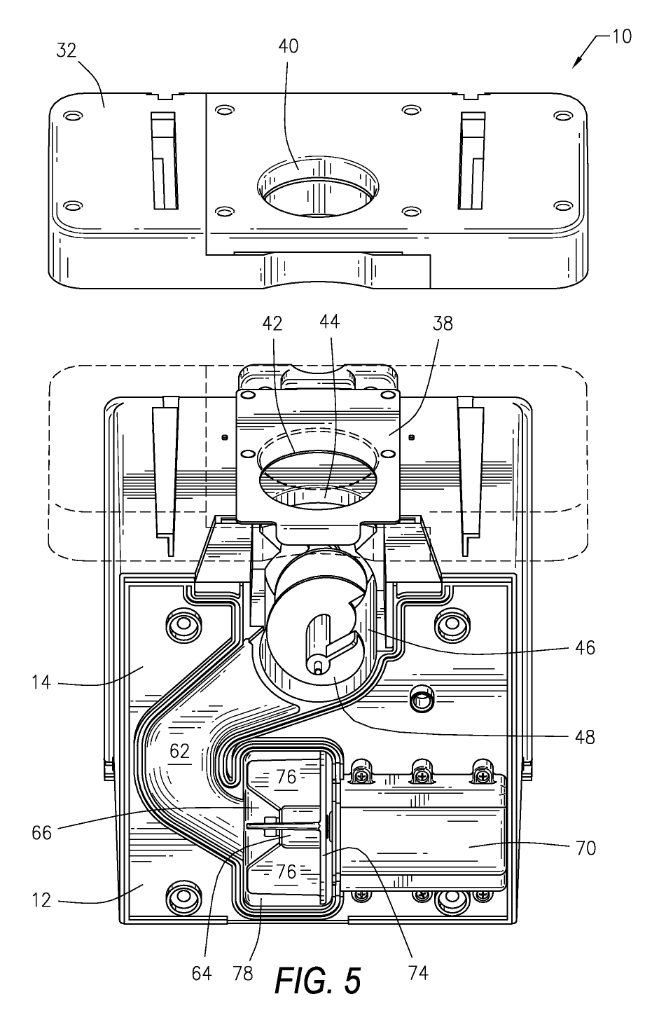

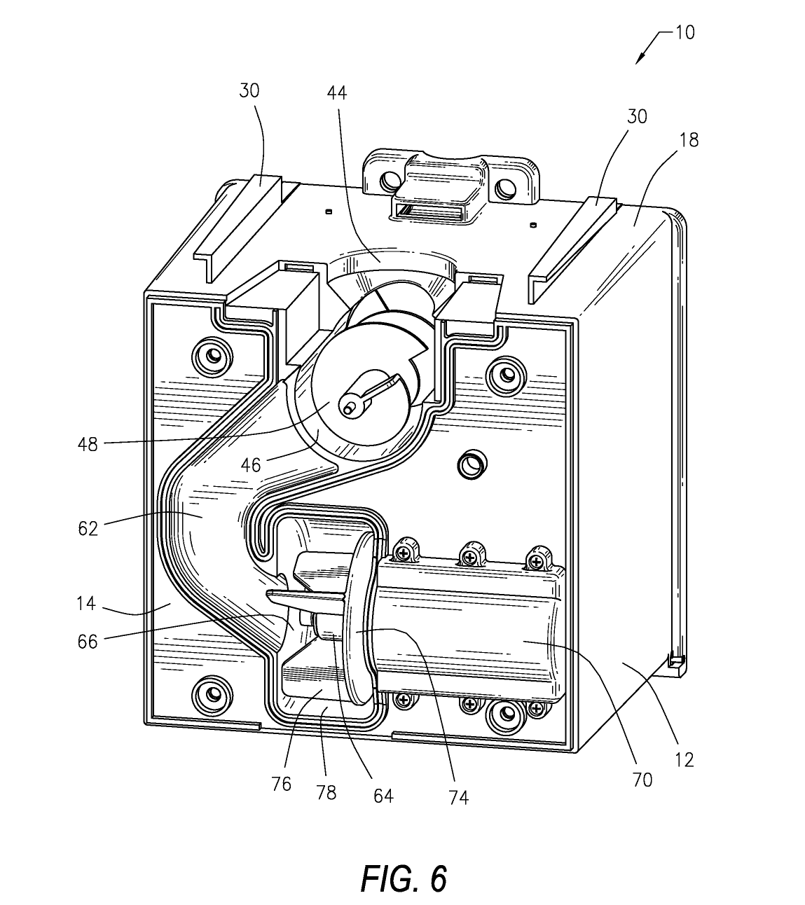

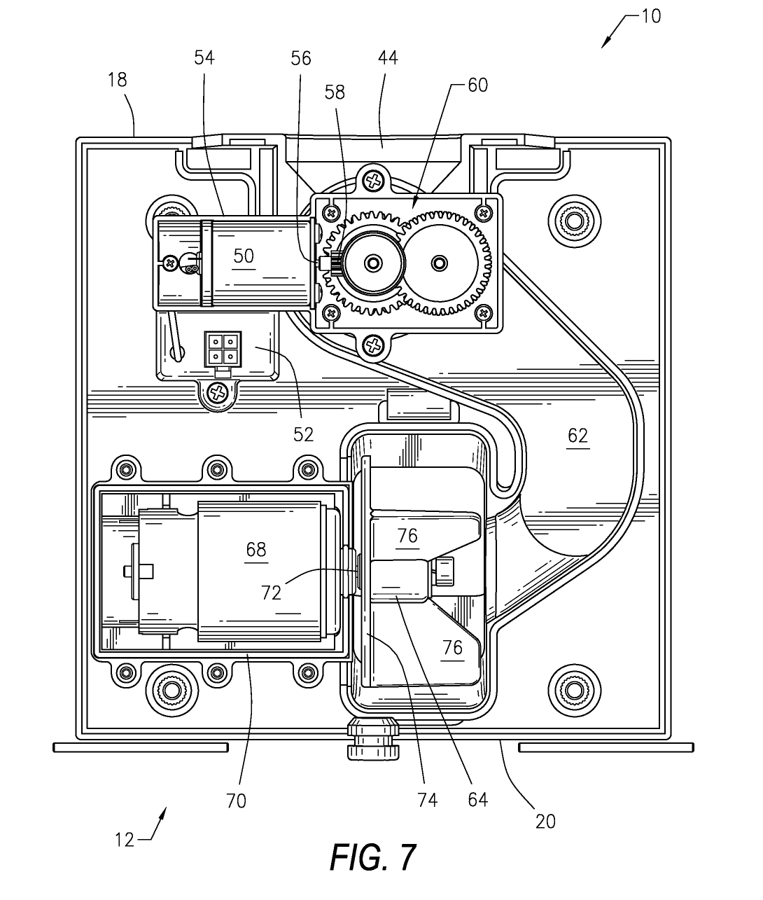

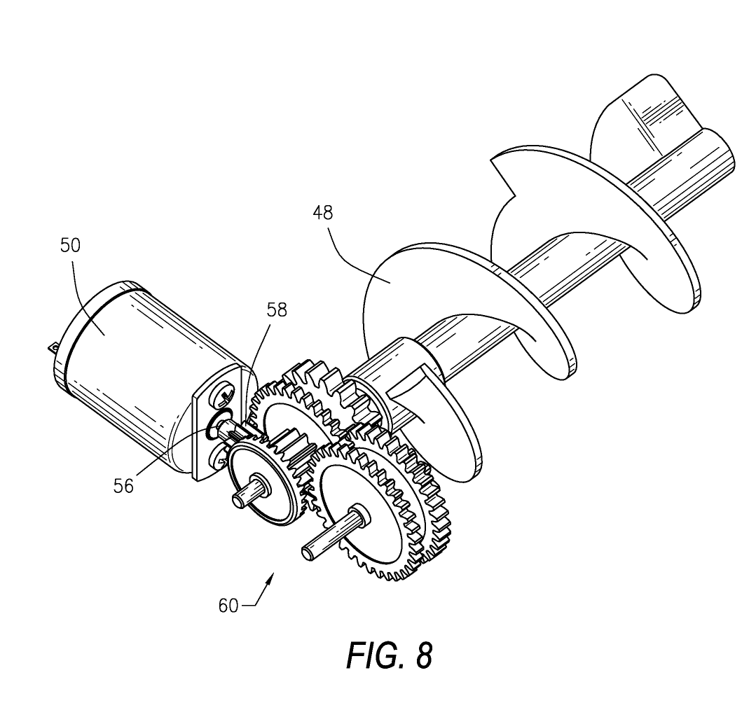

Referring now to FIGS. 5 through 7, the feed opening 44 in the top 18 of the housing 12 opens to a upper substantially cylindrical channel 46 having a substantially horizontally aligned auger 48 rotatably disposed therein. The auger 48 is powered by a first motor 50 connected to a power supply (not shown), such as a six (6) volt battery. In addition, the first motor 50 is connected to a connection terminal 52 having control circuits or feeder timer in order to drive and control the first motor 50. The first motor 50 is housed within a first motor housing 54, which is secured to the housing 12 of the directional feeder 10. The first motor 50 also includes an axle 56, which terminates in a gear 58. The rotational movement of the axle 56 is transferred to rotational movement of the auger 48 via a series of gear sprockets 60, as illustrated in FIGS. 7 and 8.

The auger 48 directs the feed pellets from the opening 44 in the top 18 of the housing 12 to a curved feed chute 62, where the feed pellets are gravity feed to a paddle wheel 64 for dispersion. As illustrated, a center axis of the feed opening 44 in the top 18 of the housing 12 is substantially perpendicular to a center axis of the paddle wheel 64. Further, the paddle wheel 64 is substantially perpendicular to the auger 48. The paddle wheel 64 is rotatably disposed within a lower substantially cylindrical channel 66 and is powered by a second motor 68, such as another six (6) volt motor connected to the power supply or an additional power supply (not shown). Similar to the first motor 50, the second motor 68 is connected to the connection terminal 52. The second motor 68 is housed within a second motor housing 70, which is secured to the housing 12 of the directional feeder 10. The second motor 68 includes an axle 72 that is secured to the center axis of the paddle wheel 64 in order to cause the paddle wheel 64 to rotate within the lower substantially cylindrical channel 66. The paddle wheel 64 includes a substantially vertical base plate 74 and a plurality of radially projecting blades 76 in close proximity to an inner wall 78 of the lower substantially cylindrical channel 66 of the housing 12 of the directional feeder 10. As the feed pellets are feed from the chute 62, the radially projecting blades 76 of the paddle wheel 64 scoop the feed pellets and accelerate the feed pellets along the inner wall 78 of the lower substantially cylindrical channel 66 of the housing 12 of the directional feeder 10 until an exit port 80 is reached. When the accelerated feed pellets reach the exit port 80 of the housing 12 of the directional feeder 10, the feed pellets' inertia carries them out the exit port 80, and the directional exit chute 22 if utilized, for dispersion.

Whereas, the devices have been described in relation to the drawings and claims, it should be understood that other and further modifications, apart from those shown or suggested herein, may be made within the spirit and scope of this invention.

What is claimed is:

1. A directional feeder for fish and game, said feeder comprising:
a housing having a front, a back, a top and a bottom, the top of the housing having a feed opening;
a substantially horizontal auger rotatably disposed within an upper substantially cylindrical channel of the housing;
a paddle wheel rotatably disposed within a lower substantially cylindrical channel of the housing, the paddle wheel having a plurality of radially projecting blades in close proximity to an inner wall of the lower substantially cylindrical channel of the housing;
a curved feed chute intermediate of the upper substantially cylindrical channel of the housing and the lower substantially cylindrical channel of the housing; and
an exit port from the lower substantially cylindrical channel of the housing.

2. The feeder of claim 1 further comprising:
a pair of brackets on the top of the housing intermediate of the front and the rear of the housing;
a mounting bracket removably secured to the pair of brackets on the top of the housing, the mounting bracket having a feed opening therethrough,
a gate slidably engaged to the mounting bracket, the gate having a feed opening therethrough;

3. The feeder of claim 2 wherein each of the brackets of the pair of brackets are a substantially inverted L-shape.

4. The feeder of claim 3 wherein the mounting bracket comprises a pair of channels having a mating configuration with the substantially inverted L-shaped brackets.

5. The feeder of claim 3 wherein each of the substantially inverted L-shaped brackets has a tapered edge such that each of the substantially inverted L-shaped brackets is wider towards the rear of the housing.

6. The feeder of claim 2 wherein the mounting bracket further comprises a pair of latches at a rear portion for locking the mounting bracket to the pair of brackets.

7. The feeder of claim 1 further comprising a directional exit chute secured to a front cover of the housing.

8. The feeder of claim 1 further comprising a hinged door releasably secured to the rear of the housing by way of a pair of hinges and a door latch.

9. The feeder of claim 2 wherein the feed opening of the top of the housing, the feed opening of the mounting bracket and the feed opening of the gate are axially spaced and coaxially aligned.

10. The feeder of claim 1 further comprising:
a first motor housed within a first motor housing secured to the housing of the feeder, the first motor having an axle, and wherein the rotation of the axle of the first motor is transferred to the auger via a series of gear sprockets;
a second motor housed within a second motor housing secured to the housing of the feeder, the second motor having an axle, and wherein the axle of the second motor is secured to a center axis of the paddle wheel; and
at least one power supply for powering the first motor and the second motor.

11. The feeder of claim 1 wherein the paddle wheel further comprises a substantially vertical base plate.

12. The feeder of claim 1 wherein a center axis of the feed opening of the top of the housing is substantially perpendicular to a center axis of the paddle wheel.

13. The feeder of claim 1 wherein a center axis of the paddle wheel is substantially perpendicular to a center axis of the auger.

14. A directional feeder for fish and game, said feeder comprising:
a housing having a front, a back, a top and a bottom, the top of the housing having a feed opening, the housing having an upper substantially cylindrical channel and a lower substantially cylindrical channel with a curved feed chute intermediate of the upper substantially cylindrical channel and the lower substantially cylindrical channel;
a substantially planar gate slidably engaged to the housing, the gate having a feed opening therethrough;
a substantially horizontal auger rotatably disposed within the upper substantially cylindrical channel of the housing;
a paddle wheel rotatably disposed within the lower substantially cylindrical channel of the housing, the paddle wheel having a substantially vertical base plate and a plurality of radially projecting blades in close proximity to an inner wall of the lower substantially cylindrical channel of the housing; and
wherein the feed opening of the top of the housing and the feed opening of the gate are axially spaced and coaxially aligned, wherein the axis of the feed opening of the top of the housing is substantially perpendicular to a center axis of the paddle wheel, and wherein a center axis of the paddle wheel is substantially perpendicular to a center axis of the auger.

15. The feeder of claim 14 further comprising the front of the housing having a front cover removably secured thereto.

16. The feeder of claim 14 further comprising a pair of brackets on the top of the housing intermediate of the front and the rear of the housing.

17. The feeder of claim 16 further comprising a mounting bracket removably secured to the pair of brackets on the top of the housing, and the mounting bracket having a feed opening therethrough.

18. The feeder of claim 16 wherein each of the brackets of the pair of brackets on the top of the housing has a substantially inverted L-shape.

19. The feeder of claim 18 wherein the mounting bracket comprises a pair of channels having a mating configuration with the substantially inverted L-shaped brackets.

20. The feeder of claim 18 wherein each of the substantially inverted L-shaped brackets has a tapered edge such that each of the substantially inverted L-shaped brackets is wider toward the rear of the housing.

21. The feeder of claim 17 wherein the mounting bracket further comprises a pair of latches at a rear portion for locking the mounting bracket to the pair of brackets.

22. The feeder of claim 17 wherein the feed opening of the mounting bracket is axially spaced and coaxially aligned with the feed opening of the top of the housing and the feed opening of the gate.

23. The feeder of claim 14 further comprising a directional exit chute secured to the front cover of the housing.

24. The feeder of claim 14 further comprising a hinged door releasably secured to the rear of the housing by way of a pair of hinges and a door latch.

25. The feeder of claim 14 further comprising an exit port from the lower substantially cylindrical channel of the housing;

26. The feeder of claim 14 further comprising:
a first motor housed within a first motor housing secured to the housing, the first motor having an axle, and wherein the rotation of the axle of the first motor is transferred to the auger via a series of gear sprockets;
a second motor housed within a second motor housing secured to the housing, the second motor having an axle, and wherein the axle of the second motor is secured to the center axis of the paddle wheel; and
at least one power supply for powering the first motor and the second motor.
